(19) United States
(12) Patent Application Publication
(10) Pub. No.: US 2017/0156309 A1
(43) Pub. Date: Jun. 8, 2017

(54) Mobile Rapid Deploy Guard Tower

(71) Applicant: Gerard Muegerl, Churubusco, IN (US)

(72) Inventor: Gerard Muegerl, Churubusco, IN (US)

(21) Appl. No.: 14/961,060

(22) Filed: Dec. 7, 2015

(51) Int. Cl. A01M 31/02; E04H 12/18

(52) U.S. Cl. CPC A01M 31/02; E04H 12/18

(57) ABSTRACT

A transportable elevating security tower, having: a selectively closable base housing, an observation enclosure, an electrically powered hydraulic lift apparatus, and electronic control device, adapted to activate said hydraulic lift system.

### BACKGROUND

1. Field of the Invention

The present invention relates to security tower, and, more particularly, to a security tower that can be easily moved from once place to another and erected on site with minimal effort.

2. Description of the Related Art

Security towers are useful to users because such towers permit a wide view of one's surroundings for hunting, observation, or security purposes. The typical observation tower is designed in a rigid manner requiring that the user take special efforts to find the ideal location for placement because moving such a tower can be cumbersome. In addition, the typical tower requires a large amount of time to assemble and erect. Unfortunately, most users are in need of security towers that can be placed in less than ideal locations within a small time window. The present invention satisfies this need by providing a portable security tower that can be moved from site to site easily and erected in less than ideal locations without a lot of time expended.

Hunters, photographers, and security personnel benefit from means to disguise or hide themselves or otherwise limit the likelihood of being noticed or recognized by wild animals or other people. Such means permit such persons to approach or remain in reasonably close and effective proximity to one's observation goal or security threat.

U.S. Pat. No. 2,256,702 discloses a combination display stand and sentinel tower for use in stores for the display of merchandise and also for use for housing a guard comfortably and in a manner enabling the guard to observe various parts of the store, the customers and clerks, and the action of such persons.

U.S. Pat. No. 3,633,904 discloses a rotary elevator observation tower. The tower body has an elevator body mounted on the outside thereof for vertical movement on the tower body. An annular observation room is mounted on the elevator body and rotatable therearound at an inclination to the horizon. An annular platform is provided at the bottom of the tower which is also inclined at the same angle, and surrounds the observation room when the observation room is at its lowest position.

U.S. Pat. No. 6,688,429 discloses a portable tower apparatus, convertible between a lowered transport configuration and a raised observation configuration, comprising an elongate main member that functions as the main structural element of a trailer assembly when the apparatus is deployed in the lowered transport configuration, and the main structural element of a freestanding tower, when the apparatus is deployed in the raised observation configuration. The apparatus is deployed in the raised tower configuration by tipping the main member up, so that the base members, attached to one end thereof, rest on the ground, attaching the platform to the other end of the main member, and attaching the brace, which is also a ladder, to the platform.

U.S. Pat. No. 8,151,934 discloses a portable observation tower and system of raising and lowering the tower. The tower has a tower box with two fixed sectioned front legs and two hinged sectioned back legs. To raise the tower front legs are pulled toward back legs with a winch system mounted on a trailer hitch system. Rolling landing gear is lowered and drawn by winch to a front most locking position. This raises the mid section of tower box reducing the angle of front legs to back legs. Once complete the winch line can be attached to an axle of back legs to draw back legs to front legs. This process elevates tower to its full upright position. Wheels are provided on back legs and on trailer hitch system for movement of the tower. The lowering process occurs in reverse order of the raising process.

U.S. Pat. No. 8,696,479 discloses a tower having a moveable observation enclosure. The observation tower comprises an upright support member with an annular observation enclosure that projects radially outward from the support member and has a tapering aerodynamic exterior profile. The observation enclosure is moveable up and down the support member.

U.S. Pat. No. 5,409,081 discloses a mobile elevated hunting apparatus including a hunting stand having a seat for holding the hunter in a seated position, framing around the seat and one or more legs attached to the seat for elevating the seat above the ground. The apparatus further includes a motorized vehicle for supporting and transporting the hunting stand. Finally, the apparatus includes a pivot bracket connecting the hunting stand with the motorized vehicle, suitable for positioning the hunting stand in a first transporting position fully on the vehicle and for positioning the hunting stand in a second hunting position with the hunting stand legs on the ground.

U.S. Pat. No. 6,523,641 discloses a trailer-mounted, retractable elevated hunting stand. The stand comprises a wheeled trailer, suitable for pulling behind a tow vehicle. The elevated stand is hingedly mounted on the trailer in a “jack-knife” configuration, with a main shaft mounted via a hinge to the trailer, and a platform atop the shaft. The platform is hinged to permit rotation for compact storage. A spring biases the shaft toward a vertical position. To use the stand, the shaft is rotated to the vertical position and the seating platform is rotated on its shaft mounting so as to be substantially horizontal when the shaft is vertical. The shaft is then locked in place. A ladder permits access to the elevated platform. The shaft telescopes for additional height if desired.

U.S. Pat. No. 6,637,549 discloses a mobile observation stand assembly including a platform that may be in a lowered position for transport and an elevated position for use in a desired location. The assembly includes a base supported by a wheel and axle assembly, with an articulated anterior frame and an articulated posterior frame attached to the base. The posterior and anterior frames each include a basal frame and a principal frame that are jointed by a rollover lock joint that allows for pivotal movement. A leveraging cam is attached to the posterior frame, with the cam supporting the anterior frame during repositioning of the assembly.

U.S. Pat. No. 5,105,908 to Freund discloses a ladder apparatus to which may be attached a platform. The ladder and platform may be collapsed and, in such collapsed configuration attached to either a wheel or ski assembly and to a motorized vehicle for transport.

U.S. Pat. No. 5,314,042 to Adams discloses a hinged sectional ladder and platform assembly that may, when folded for transport be attached to front and rear wheel and axle assemblies.

U.S. Pat. No. 5,566,780 to Bambrough describes a ladder-based cart apparatus with an attachable platform that may, for transport, be pushed or pulled on wheel assemblies.

U.S. Pat. No. 5,839,538 to Magyar discloses a foldable portable stand comprised of top and bottom ladder sections hinged to each other and a platform connected to the top ladder section. The ladder sections, platform, and ancillary supporting members can be folded together and, in that conformation, pushed or pulled by an individual on wheels attached to lower ladder section.

U.S. Pat. No. 5,295,555 to Strange teaches a wheeled trailer chassis including a flat load bed for carrying an all-terrain vehicle and attached lift booms that can be raised from a horizontal position with hydraulic cylinders anchored to the trailer chassis and the lift booms. Attached to the lift booms, at the ends distal to the trailer-chassis attachment points is a platform.

U.S. Pat. No. 5,564,523 to Howard discloses a scaffold structure that, when assembled on a trailer chassis, supports a raised platform stabilized by support lines. The platform, scaffolding members, and support lines, when dissembled may be packed onto the trailer chassis for transport.

U.S. Pat. No. 6,186,271 to Borries and Scarborough reveals a collapsible hunting stand and game-carrier assembly comprising a seat supported by three or more legs. The stand collapses and folds up for transport, giving rise to a considerable number of hinges and like parts that are subject to wear and failure.

What is needed in the art is a portable tower apparatus that is simpler and more convenient to assemble, use, and transport than prior towers. It is a further object of the present invention to provide such a tower apparatus that includes a larger platform that is stabilized to support one or more persons in an elevated location. It is a further object of the present invention to provide such a tower apparatus that includes a camouflage cover for the platform.

### SUMMARY

In one exemplary embodiment, the present invention may include a transportable elevating security tower apparatus, said tower comprising: a selectively closable base housing, said housing comprising a housing floor; an observation enclosure, said observation enclosure comprising at least four walls, a roof, and a floor; an electrically powered hydraulic lift device, said device comprising a scissor lift connected to a hydraulic actuator, said hydraulic lift device mechanically connected to said floor of said base housing and to said floor of said observation enclosure; and electronic controller, said controller operatively connected to said hydraulic lift and adapted to activate said hydraulic lift.

In another exemplary embodiment, the present invention may further compromise a selectively operable locking turnbuckle functionally disposed between said base housing and said observation enclosure.

In another exemplary embodiment, the present invention may further compromise a further comprising an power source electrically connected to said hydraulic lift, said power source selected from the group consisting of a battery, a rechargeable battery, an AC power source; a generator; and a solar power source.

In another exemplary embodiment, the present invention may further compromise a mechanical actuator operatively attached to said scissor lift, said mechanical actuator selected from the group consisting of a manual rotating crank; a manual ratchet; and a manual pulley system.

In another exemplary embodiment, the present invention may further compromise a further comprising at least one aperture disposed through a wall of said observation enclosure.

In another exemplary embodiment, the present invention may further compromise a movable weapon mount attached to said observation enclosure such that an attached weapon is usable through said aperture.

In another exemplary embodiment, the present invention may further compromise a door disposed through said floor of said observation enclosure.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a security tower in accordance with the present invention, with the tower fully deployed.

FIG. 2 shows a hydraulic lift system in accordance with the present invention.

FIG. 3 shows a weapon attachment for use with the present invention.

FIG. 4 shows a security tower in accordance with the present invention, with the tower fully non-deployed.

FIG. 5 shows the security tower shown in FIG. 3 with the tower on a trailer.

FIG. 6 shows a locking turnbuckle for use with the present invention.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

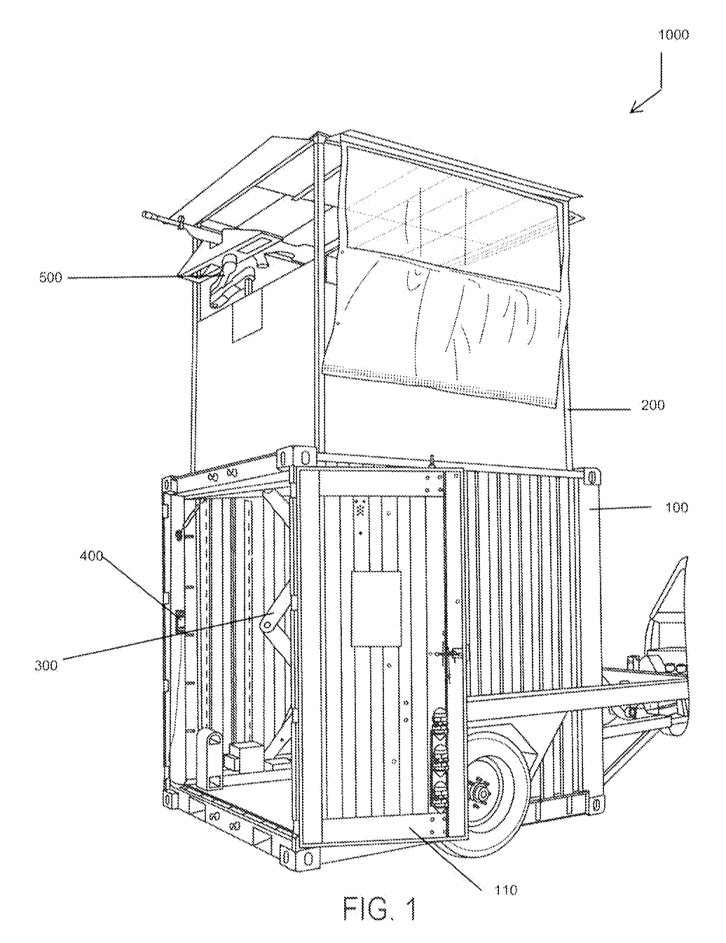

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, there is shown a perspective view of an exemplary mobile security tower 1000 according to the present invention in a fully deployed position. As illustrated in FIG. 1, mobile tower 1000 generally comprises selectively closable base housing 100, observation enclosure 200 movably disposed within housing 100, hydraulic lift 300 mechanically connected between housing 100 and observation enclosure 200, electronic controller 400 operatively connected to hydraulic lift 300 and adapted to activate hydraulic lift 300, and weapon mount 500 attached to observation enclosure 200.

Referring still to FIG. 1, housing 200 preferably comprises a ballistic resistant steel of desired specification. Housing 200 preferably further comprises a generally cuboid shape having five sides with the top side open for deployment of observation enclosure 200. As further illustrated in FIG. 1, observation enclosure 200 is movingly disposed within housing 100. Housing 100 further comprises access doors 110 to permit entry by users into tower 1000 when tower 1000 is in the fully deployed position.

Referring again to FIG. 1, there is further shown hydraulic lift 300 disposed within housing 100. Hydraulic lift 400 is attached to the interior of housing 100 and to the bottom of observation enclosure 200 by generally known means, such as welding or the use of fasteners.

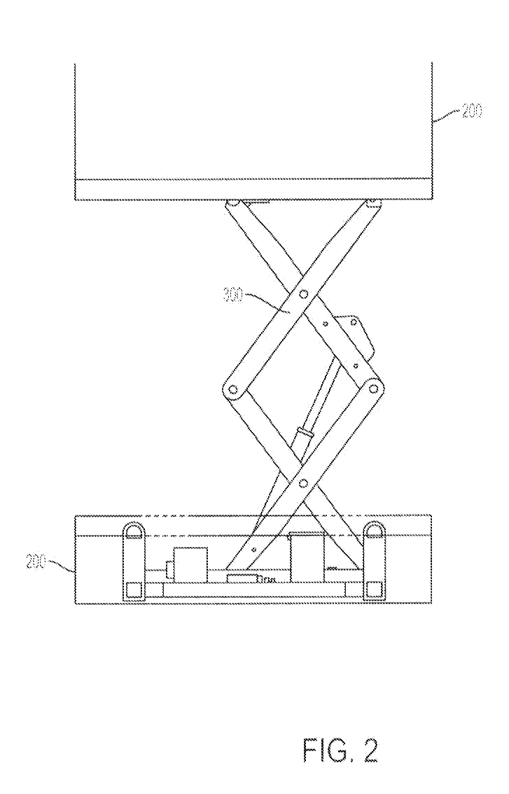

Referring now to FIG. 2, there is shown a detailed view exemplary hydraulic lift 300. Those of ordinary skill in the relevant art will appreciate that other known means may be used to lift enclosure 200 from within housing 100, including a hydraulic ram, a human powered crank and gear system, and external crank and gear system, or other known means.

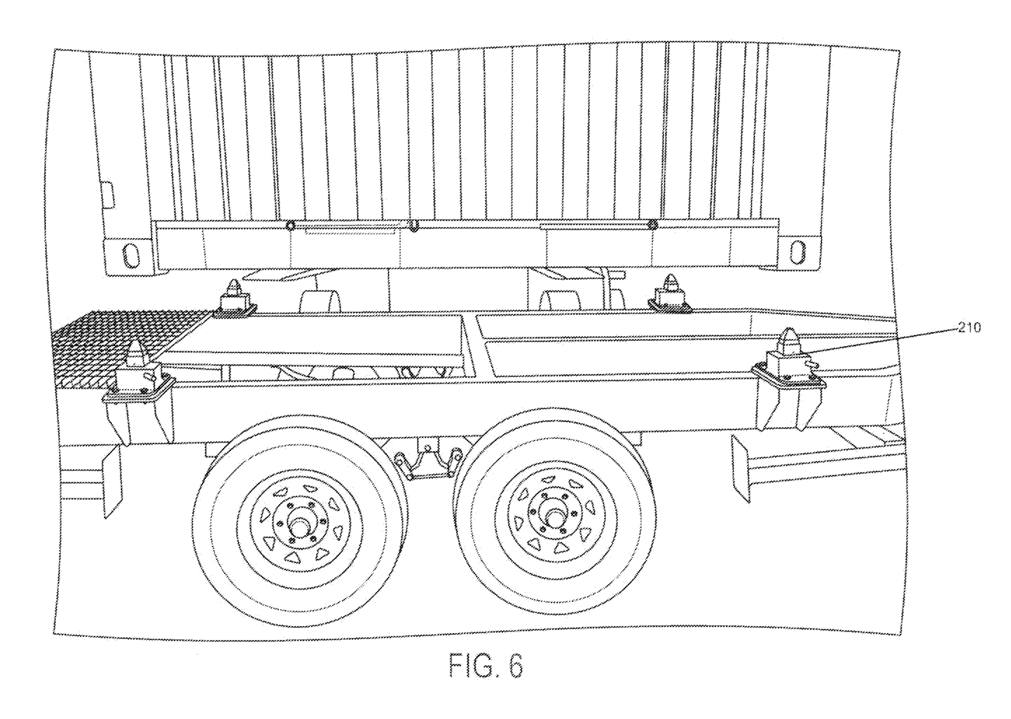

Referring still to FIG. 2, hydraulic lift 300 preferably comprises a battery and a control module. Those of ordinary skill in the art will appreciate that the battery 310 may be a chemical battery, a rechargeable battery, a solar power source, a solar rechargeable battery, or any other electrical power source. The control module 400 is functionally connected to the battery to activate hydraulic lift 300 to a raised/deployed position. Once raised, the scissor lift is locked into position with a turnbuckle 210 (FIG. 6) in each corner. Those of ordinary skill in the art will also appreciate that turnbuckle 210 is merely illustrative as a mechanism for locking enclosure 200 in place relative to housing 100.

Referring again to FIG. 1, enclosure 200 preferably comprises a ballistic resistant steel of a predetermined specification. Enclosure 200 further comprises at least one aperture 220 so that a user may see out of enclosure 200. Enclosure 200 further comprises an access between the bottom of enclosure 200 and housing 100. The access may comprise a sliding or hinged door. Enclosure 200 may further comprise a ladder for entering enclosure 200 from the interior of housing 100. Enclosure 200 may also comprise curtains 230 or rigid inserts (not shown) to selectively close apertures 220.

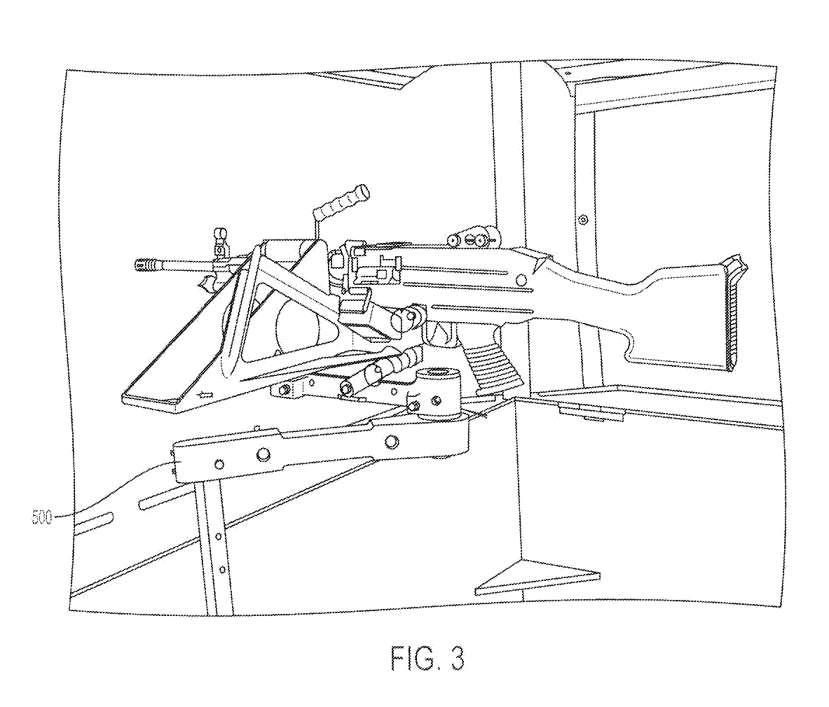

Referring next to FIG. 3, there is shown weapon mount 500 for use with the present invention. As illustrated in FIG. 3, weapon mount 500 is disposed through aperture 220 of enclosure 200. Weapon mount 500 preferably comprises multiple point of articulation to maximize the ability to properly aim an attached weapon.

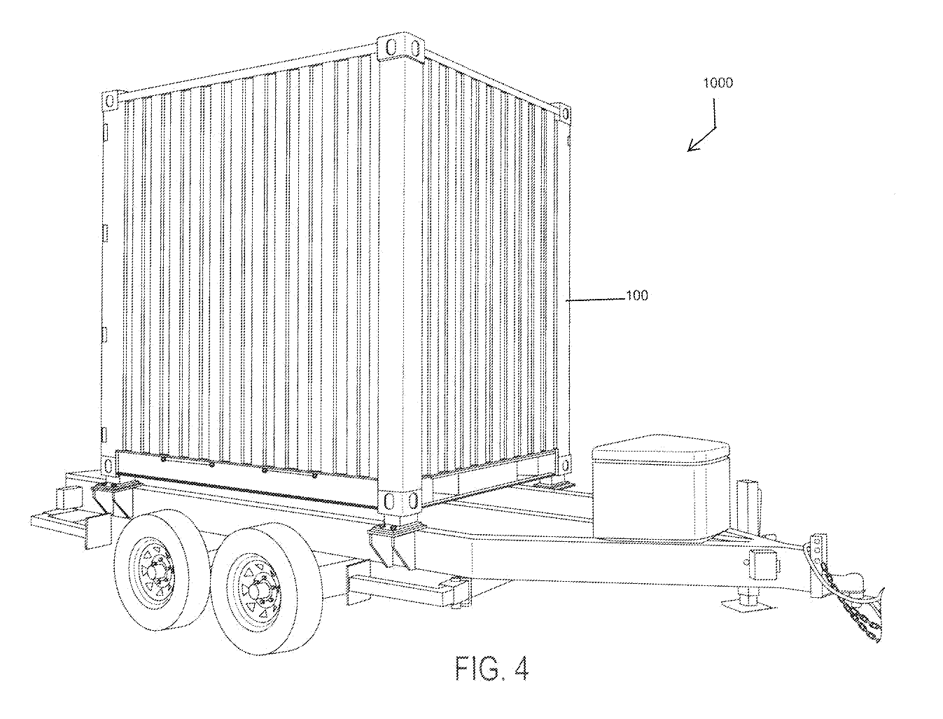

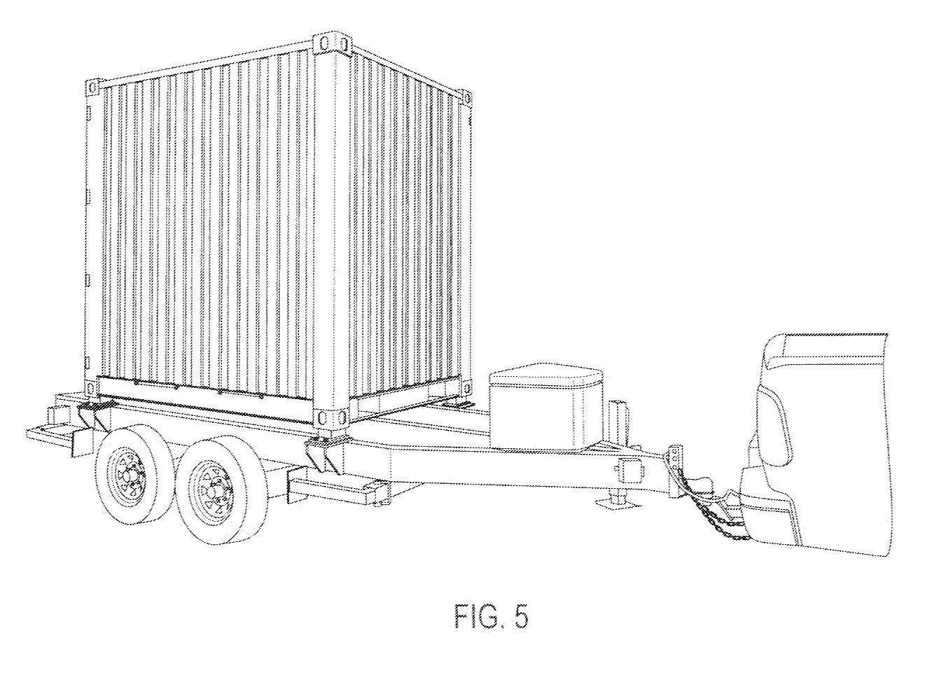

Referring next to FIG. 4, there is shown security tower 1000 with the tower fully non-deployed. Additionally, FIG. 5 shows security tower 1000 on a trailer. Security tower 1000 of the present invention can be towed behind any vehicle with ball or pintle hitch.

The present tower's ability to be rapidly deployed makes it ideal for hunting, military checkpoints, dock security, border patrol operations and many other applications requiring mobile security. The present tower can be shipped separately from a trailer.

Once it is on site, a tower in accordance with the present invention can be manually deployed in about 10 minutes. The trailer outriggers are put into deployment position to stabilize the tower. It can be placed in the transport mode without heavy equipment and be ready for recovery or repositioning in about 10 minutes. Once it has been put back into transport mode, it can be towed to a new location and redeployed or stored.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A transportable elevating security tower apparatus, said tower comprising: a selectively closable base housing, said housing comprising a housing floor; an observation enclosure, said observation enclosure comprising at least four walls, a roof, and a floor; an electrically powered hydraulic lift device, said device comprising a scissor lift connected to a hydraulic actuator, said hydraulic lift device mechanically connected to said floor of said base housing and to said floor of said observation enclosure; and electronic controller, said controller operatively connected to said hydraulic lift and adapted to activate said hydraulic lift.

2. The apparatus of claim 1, further comprising a selectively operable locking turnbuckle functionally disposed between said base housing and said observation enclosure.

3. The apparatus of claim 1, further comprising an power source electrically connected to said hydraulic lift, said power source selected from the group consisting of a battery, a rechargeable battery, an AC power source; a generator; and a solar power source.

4. The apparatus of claim 1, further comprising a mechanical actuator operatively attached to said scissor lift, said mechanical actuator selected from the group consisting of a manual rotating crank; a manual ratchet; and a manual pulley system.

5. The apparatus of claim 1, further comprising at least one aperture disposed through a wall of said observation enclosure.

6. The apparatus of claim 5, further comprising a movable weapon mount attached to said observation enclosure such that an attached weapon is usable through said aperture.

7. The apparatus of claim 1, wherein said observation enclosure comprises a door disposed through said floor of said observation enclosure.
